(19) United States
(12) Patent Application Publication
(10) Pub. No.: US 2026/0344850 A1
(43) Pub. Date: Nov. 5, 2026

(54) ILLUMINATED BELT BUCKLE FOR A SEAT BELT DEVICE OF A MOTOR VEHICLE, AND METHOD FOR ACTUATING AN ILLUMINATED BELT BUCKLE FOR A SEAT BELT DEVICE OF A MOTOR VEHICLE

(71) Applicant: Autoliv Development AB, Vargarda (SE)

(72) Inventors: Michel HERMANN, Pinneberg (DE); Timo NEHRENHEIM, Hamburg (DE); Iulian ROTARIU, Kölln-Reisiek (DE); Leif SCHATTAUER, Elmshorn (DE)

(21) Appl. No.: 19/486,238

(22) PCT Filed: May 23, 2024
(86) PCT No.: PCT/EP2024/064252

§ 371 Date: Nov. 20, 2025

(30) Foreign Application Priority Data
May 31, 2023 (DE) 10 2023 114 230.5

(51) Int. Cl. A44B 11/25; B60Q 3/242

(52) U.S. Cl. CPC A44B 11/2565; B60Q 3/242

(57) ABSTRACT

An illuminated belt buckle for a seat belt device of a motor vehicle, comprising a housing, a pushbutton which can be moved in the housing, an insert slot, which is arranged adjoining the pushbutton, for inserting a belt tongue which can be locked in the belt buckle, and at least one annular light source which surrounds the insert slot and the pushbutton, where the light source has a plurality of individually actuable sections arranged distributed over the circumference, where the light source is activated or deactivated by activation or deactivation of the adjoining sections with a time delay in a continuous sequence.

The present invention relates to an illuminated belt buckle for a seat belt device of a motor vehicle with the features of the preamble of claim 1 and a method for actuating an illuminated belt buckle for a seat belt device of a motor vehicle with the features of the preamble of claim 8.

Belt buckles for seat belt devices of motor vehicles serve in general to securely lock to a vehicle a belt tongue movably guided on a belt webbing or securely connected to an end of a belt webbing. For this purpose, the belt buckle has an insert slot for the belt tongue and a locking mechanism which can be released via a pushbutton. The locking mechanism is spring-loaded and automatically locks the belt tongue upon insertion into the insert slot. To release the belt tongue, a passenger buckled up with the seat belt presses down the pushbutton, whereby the locking mechanism is released, and the belt tongue is ejected by a released spring force of the locking mechanism.

Such belt buckles have been prior art for many years. A problem with such belt buckles is that, to buckle up, the occupant has to find the comparatively narrow insert slot of the belt buckle into which he inserts the belt tongue for fastening the seat belt.

It is known from DE 39 04 125 A1 to provide a belt lock with a light source, wherein the light source is coupled to predetermined light-emitting surfaces of the belt buckle via a light-conducting material. The light-emitting surfaces in this case are the pushbutton itself and/or a radiating surface arranged on a side face, opposite the pushbutton, of the insert slot. Since the pushbutton must be designed to be displaceable for its function, the light-conducting material fixedly arranged in the pushbutton must be positioned in the pushbutton in such a way that the light-entry surface of the light-conducting material is photometrically connected to the external light source when the pushbutton is in the non-pressed position. If the light entry surface of the light-conducting material in this position is not photometrically connected to the external light source due to pro-duction-related shape and position deviations or mechanical influences, the light is not, or not completely, fed into the pushbutton, such that the pushbutton itself does not illuminate, or illuminates more weakly than desired.

It is further known from DE 10 2007 047 704 A1 to provide a light conductor in the belt buckle, which light conductor has at least two light-emitting surfaces which are arranged at the ends of the insert slot. The light-emitting surfaces them-selves are triangular in shape and arranged in a free triangular area of the end face of the housing between the edge of the housing and a conical side face of the pushbutton. The light-emitting surfaces are dimensioned in particular in such a way that they fill out the free areas in the corners of the end face of the housing as extensively as possible in order to achieve the best possible luminosity.

From U.S. Pat. No. 5,892,436 A, an illuminated belt buckle is known in which a light source is connected via a plurality of light conductors, wherein the light conductors emerge at an end face of the housing and therefore form a plurality of luminous points which are arranged circumferentially around the pushbutton of the belt buckle or around the insert slot. However, this solution is complex and expensive; moreover, the light conductors lie in the direction of movement of the pushbutton, so that there is a risk of damage to the light conductors when the pushbutton is operated to open the belt buckle.

From document DE 10 2015 215 254B4 , an illuminated belt buckle is known in which the light-emitting surface is formed by a circumferential surface light source on the end face of the housing, wherein the surface light source is designed as a luminous thin-film component. An additional ring element is provided on the end face of the housing and covers the surface light source on the end face of the belt buckle and on the radial outside of the belt buckle and therefore protects it from damage. The ring element is manufactured using a two-component injection-molding process and has a translucent region on the end face in the form of a continuous circumferential band and an opaque region on its radial outer side, such that the belt buckle is intentionally illuminated only on the end face.

The object of the invention is to provide an illuminated belt buckle with improved visibility for the occupant and a method for actuating such a belt buckle.

In order to achieve the object, an illuminated belt buckle with the features of claim 1 is proposed. Further preferred embodiments of the invention can be found in the dependent claims, the figures, and the associated description.

According to claim 1, an illuminated belt buckle for a seat belt device of a motor vehicle is proposed, having a housing, a pushbutton which can be moved in the housing, an insert slot, which is arranged adjoining the pushbutton, for inserting a belt tongue which can be locked in the belt buckle, and at least one annular light source which surrounds the insert slot and the pushbutton, wherein the light source has a plurality of individually actuable sections arranged distributed over the circumference, and the light source is activated by activation or deactivation of the adjoining sections with a time delay in a continuous sequence.

This activates the light source in the form of a surrounding activation or deactivation zone, which can further increase the occupant's attention, since the pure illumination is supplemented by a dynamic component. The proposed solution allows for dynamically changing illumination of the belt buckle without having to interrupt the illumination. The illumination, through the proposed activation, can be designed, for example, as a closing or opening light ring.

It is further proposed that the sections be deactivated in a time-delayed manner after activation, or that they be activated in a time-delayed manner after deactivation. This allows the illumination to be designed as an at least partially encircling light point or a partially encircling dark zone in the other-wise luminous light ring.

It is further proposed that the light source have two sub-groups of sections in which the sections of the light source are activated or deactivated in a time-delayed manner in different directions in the continuous sequence. The advantage of the proposed solution is that, by activating or deactivating the sections of the light source in two sub-groups and activating them in different directions within the two sub-groups, a lighting pattern is achieved in a repeating lighting cycle, which has two points of light or dark zones that move away from each other in an initial phase of a lighting cycle and move towards each other in a final phase of a lighting cycle. This lighting pattern can further increase the viewer's attention to the belt buckle, thus making it easier to find.

It is further proposed that the two sub-groups of the sections form two symmetrically arranged halves of the annular light source, which respectively comprise one half of the pushbutton and one half of the insert slot and supplement one another to form the annular light source. Thus, the sections of a sub-group each comprise half of the pushbutton and the insert slot, and therefore each have a C-shape. The other sub-group of sections comprises the other half of the pushbutton and the insert slot, thus completing the first sub-group to form the ring-shaped light source. The two sub-groups of the sections thus each have a C-shape with open ends facing each other.

It is further proposed that the direction of the time-delayed activation or deactivation depend upon a locking state of the belt tongue. This allows the viewer to receive additional information, through the direction of the activation or deactivation of the light source or the rotation of the light point or dark zone, as to whether the belt buckle is ready to lock a belt tongue, i.e., whether no belt tongue is yet locked in it, or whether a belt tongue is already locked in it.

It is further proposed that the sections of the sub-groups be activated or deactivated in a time-delayed and continuous manner in the direction of the insert slot when no belt tongue is locked in the belt buckle. The activation or deactivation of the light source or the rotation of the light point or dark zone thus takes place in the direction of the insert slot, wherein the illumination or dark zone converges from two sides towards the insert slot and thus indicates to the occupant where the belt tongue is to be inserted into the belt buckle or locked.

It is further proposed that the sections of the sub-groups be activated or deactivated in a time-delayed and continuous manner in the direction of the pushbutton when a belt tongue is locked in the belt buckle. This shows the occupant where the pushbutton to release the belt tongue is located, thus making it easier for the occupant to release the seat belt.

A method having the features of claim 8 is further proposed for achieving the object. Further preferred features for actuating an illuminated belt buckle can be found in dependent claims 9 to 14.

The invention is explained below using preferred embodiments with reference to the accompanying figures. In the figures:

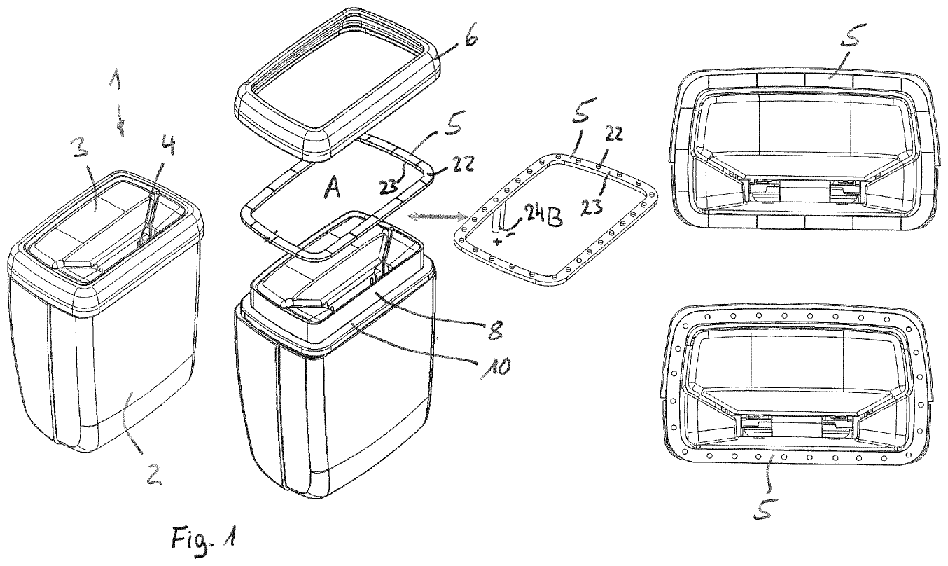

FIG. 1 shows an illuminated belt buckle according to the invention in the assembled state, in exploded view and in view of the pushbutton with a light source in two different embodiments; and

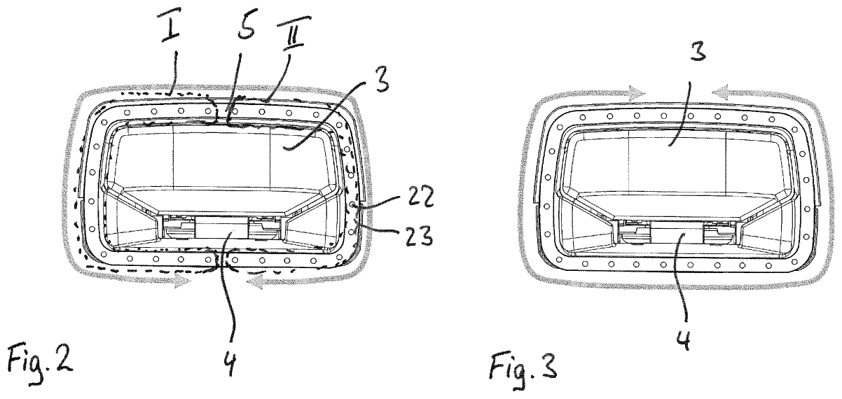

FIG. 2 shows a belt buckle according to the invention with a belt tongue (not shown) before the belt tongue is unlocked; and

FIG. 3 shows a belt buckle according to the invention before locking a belt tongue (not shown).

In FIG. 1, an illuminated belt buckle 1 according to the invention can be seen with a housing 2, a pushbutton 3 arranged on the end face, and an insert slot 4 arranged adjoining the latter for the insertion and locking of a belt tongue (not shown) of a seat belt device. In the housing 2, a locking mechanism (not shown) is provided for locking the belt tongue, which can be released by actuating the pushbutton 3 for ejecting the belt tongue in the known manner.

On the end face of the housing 2, an annular section 8 is provided which projects from a base surface 10 of the housing 2 and which encloses the pushbutton 3 and the insert slot 4 of the belt buckle 1. The base region 10 of the housing 2 is also designed to be annular and extends over the entire circumference of the housing 2 on the radial outer side of the annular section 8. Furthermore, a cover element 6, which is also annular, is provided, which is fastened, via a fastening attachment, to the outside of the housing 2 in the section forming the base surface 10. To fasten the cover element 6, it can be glued or welded, for example, to the fastening attachment on the outside of the housing 2.

The cover element 6 rests with the fastening attachment radially on the outside on the housing 2 and with the end face on the annular section 8. The cover element 6 therefore encloses an annular cavity which is bordered toward the radial inside by the annular section 8 and toward the underside by the base region 10. An annular light source 5 is arranged on the base surface 10 of the cavity 9.

The cover element 6 is integrally made of a translucent material. When the light source 5 is activated, the cavity is completely illuminated, wherein the light exits to the outside through the cover element 6 due to the one-piece, translucent design of the cover element 6. The belt buckle 1 is therefore illuminated homogeneously in a ring shape over the entire outer surface of the cover element 6, wherein the pushbutton 3 and the insert slot 4 are arranged within the luminous ring. Since the cover element 6 with the fastening attachment on the outside of the housing 2, within the scope of the possible manufacturing accuracy, abuts the annular section 8 without a gap as far as possible, the light emerges exclusively via the outer surface of the cover element 6 so that a visually high-quality illumination of the belt buckle 1 can be realized. In this regard, depending upon the requirements of the customer, in order to increase the scattering of the light, the radiation characteristics can be changed by deliberately roughening the cover element 6-for example, by etching the surface or by a specific embossed surface structure on its radial outer side or also on its radial inner side. It is also conceivable to provide a partially transparent coating of the cover element 6 which allows the light to escape when the light source 5 is activated, but prevents a view through the cover element 6 when the light source 5 is deactivated. It is also conceivable to realize the cover element 6 with a different shape or to integrate it into the light source 5, so that the cover element is part of the light source itself.

FIG. 1 shows the belt buckle 1 with a light source 5 according to a version A, which has a plurality of individual light sources 22 in the form of OLED's on a carrier material 23. The OLED's are arranged flat on the carrier material 23 and, when all OLED's are activated, together form a closed luminous ring on the surface of the light source 5.

Alternatively, according to version B, a light source 5 with a plurality of individual light sources 22 can be provided, which are formed by LED's. The LED's are combined on a carrier material 23 to form a “COB (chip on board) light strip.” A conductor structure for contacting the LED's is provided in the carrier material 23, such that the carrier material 23 can also be regarded as an annular, flexible circuit board. In addition to arranging the various electrical components, the carrier material 23 also serves to fasten the light source 5, e.g., by clipping it to the housing 2. The LED's can be designed either as monochrome LED's or as RGB LED's with a controllable color of the emitted light, wherein a mixture of such LED's can of course also be provided.

If monochrome LED's are provided, they can be made to shine by a simple, controlled current supply of between 6 V or 12 V. If RGB LED's are provided, they are preferably controlled via the LIN controller with a LIN slave and a LIN master. In this regard, the LIN slave is provided on the carrier material 23, i.e., the circuit board, which, in addition to a plus-minus connection, is also connected via a data pole to a vehicle control unit, which in this case forms the LIN master for the LIN slave. The plus-minus connection of contacts 24 is additionally supplemented by a control line (data) which forms the data pole for the LIN controller.

The individual light sources 22 form individually activatable sections of the light source 5 and can be actuated individually and independently of each other, and are activated in such a way that they are activated or deactivated with a time delay and continuously over the circumference, so that illumination of the belt buckle 1 with a closing or opening light ring can be achieved.

FIGS. 2 and 3 show a preferred embodiment of the invention in which the individual light sources 22 of the light source 5 are divided into two C-shaped sub-groups I and II, which each encompass half of the insert slot 4 and the pushbutton 3 and combine to form a closed luminous ring. The individual light sources 22 of sub-groups I and II are activated according to FIG. 2 to indicate the insert slot 4 in such a way that they are activated in a repeating illumination cycle starting from the end of the section comprising the pushbutton 3, in a time-delayed and continuous manner. The individual light sources 22 are activated continuously so that the light ring is closed in the directions of the arrows shown, wherein the last activated individual light sources 22 are the individual light sources 22 which adjoin the insert slot 4. This allows the occupant to be actively alerted to the required buckling procedure and additionally informed about the location of the insert slot 4.

In the event of an unbuckling process being initiated, which can be seen in FIG. 3, the individual light sources 22 are activated in reverse sequence, so that the light ring begins to light up starting from the pushbutton 4 and is closed adjacent to the pushbutton 3.

These described lighting cycles are then repeatedly activated until the occupant has completed the buckling or unbuckling process.

This means that the individual light sources 22 of the light source 5 are activated in sequence depending upon the locking state of the belt buckle 1. Furthermore, the individual light sources 22 can also again be deactivated or activated in a time-delayed manner after their activation or deactivation, so that the light source 5 is activated to form a circumferential light point or a circumferential dark zone.

The proposed illuminated belt buckle 1 and the proposed method for actuating the illumination of the illuminated belt buckle 1 can be further refined by closing or opening the light ring for fastening or unfastening, i.e., for locking or unlocking the belt tongue, in a lighting cycle, and the light ring then illuminating completely once or several times, preferably three times. The opening or closing of the light ring can be dimmed, i.e., occur with a lower light intensity, and the complete illumination occur with a higher light intensity.

Furthermore, customized lighting is also possible in terms of color, sequence, and lighting frequency.

1. An illuminated belt buckle for a seat belt device of a motor vehicle, having
a housing,
a pushbutton which can be moved in the housing,
an insert slot for inserting a belt tongue which can be locked in the belt buckle which slot is arranged adjoining the pushbutton, and
at least one annular light source surrounding the insert slot and the pushbutton wherein
the light source has a plurality of individually actuable sections arranged distributed over the circumference, wherein
the light source is activated or deactivated by activation or deactivation of the adjoining sections with a time delay in a continuous sequence.

2. The illuminated belt buckle according to claim 1, wherein
the sections are deactivated in a time-delayed manner after activation, or are activated in a time-delayed manner after deactivation.

3. The illuminated belt buckle according to claim 1, wherein
the light source has two sub-groups of sections in which the sections of the light source are activated or deactivated in a time-delayed manner in different directions in the continuous sequence.

4. The illuminated belt buckle according to claim 3, wherein
the two sub-groups of the sections form two symmetrically arranged halves of the annular light source, which respectively comprise one half of the pushbutton and one half of the insert slot and supplement one another to form the annular light source

5. The illuminated belt buckle according to claim 1, wherein
the direction of the continuous time-delayed activation or deactivation depends upon a locking state of the belt tongue.

6. The illuminated belt buckle according to claim 4, wherein
the sections of the sub-groups are activated or deactivated in a time-delayed and continuous manner in the direction of the insert slot when no belt tongue is locked in the belt buckle.

7. The illuminated belt buckle according to claim 4, wherein
the sections of the sub-groups are activated or deactivated in a time-delayed and continuous manner in the direction of the pushbutton when the belt tongue is locked in the belt buckle.

8. A method for actuating an illuminated belt buckle for a seat belt device of a motor vehicle, having
a housing,
a pushbutton which can be moved in the housing,
an insert slot for inserting a belt tongue which can be locked in the belt buckle which slot is arranged adjoining the pushbutton, and
at least one annular light source surrounding the insert slot and the pushbutton wherein
the light source has a plurality of individually actuable sections arranged distributed over the circumference, and
the light source is activated by a time-delayed activation or deactivation of the adjoining sections in a continuous sequence.

9. The method for actuating an illuminated belt buckle according to claim 8, wherein
the sections are deactivated in a time-delayed manner after activation, or are activated in a time-delayed manner after deactivation.

10. The method for actuating an illuminated belt buckle according to claim 8, wherein
the light source has two sub-groups of sections in which the sections are activated or deactivated in a time-delayed manner in different directions in the continuous sequence.

11. The method for actuating an illuminated belt buckle according to claim 10, wherein
the two sub-groups of the sections form two symmetrically arranged halves of the annular light source which respectively comprise one half of the pushbutton and one half of the insert slot and supplement one another to form the annular light source.

12. The method for actuating an illuminated belt buckle according to claim 8, wherein
the direction of the time-delayed activation or deactivation depends upon a locking state of the belt tongue.

13. The method for actuating an illuminated belt buckle according to claim 10, wherein
the sections of the sub-groups are activated or deactivated in a time-delayed and continuous manner in the direction of the insert slot when no belt tongue is locked in the belt buckle.

14. The method for actuating an illuminated belt buckle according to claim 10
the sections of the sub-groups are activated or deactivated in a time-delayed and continuous manner in the direction of the pushbutton when the belt tongue is locked in the belt buckle wherein
the direction of the time-delayed activation or deactivation depends upon a locking state of the belt tongue.
